(19) United States
(12) Patent Application Publication
(10) Pub. No.: US 2007/0213895 A1
(43) Pub. Date: Sep. 13, 2007

(54) Vehicle diagnostic system capable of easily acquiring data IDs for vehicle diagnosis

(75) Inventor: Seiya Nakayama, Chiryu-shi (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/716,671

(22) Filed: Mar. 12, 2007

(30) Foreign Application Priority Data
Mar. 10, 2006 (JP) 2006-066137

(51) Int. Cl. G01M 17/00

(52) U.S. Cl. 701/29; 701/33

(57) ABSTRACT

A vehicle diagnostic system is provided for readily specifying a malfunctioning portion of a vehicle. An on-vehicle electronic control unit (ECU) stores data ID retrieval tables consisting of a plurality of retrieval codes which are classified into three, i.e. function IDs indicative of function, forced driving IDs for allowing the ECU to forcedly drive an object to be controlled, and diagnostic codes indicative of types of malfunction. In the tables, data IDs are recorded being correlated to the retrieval codes. A diagnostic tool provided outside the vehicle transmits an inputted retrieval code to the ECU, which then searches through the tables to retrieve a data ID corresponding to the code for transmission to the diagnostic tool. The diagnostic tool then transmits the data ID to the ECU as a data demand. In response, the ECU transmits a data corresponding to the data ID for display on the diagnostic tool.

### CROSS-REFERENCE TO RELATED APPLICATION

This application is based on and claims the benefit of priority from earlier Japanese Patent Application No. 2006-066137 filed Mar. 10, 2006, the description of which is incorporated herein by reference.

### BACKGROUND OF THE INVENTION

1. Technical field of the Invention

The present invention relates to a vehicle diagnostic system for diagnosing malfunction of vehicles. (The term “malfunction” represents a condition of functioning improperly and may often be referred to as “disorder”, “fault”, “failure” or “abnormality”, but throughout the present specification and claims, the term “malfunction” is mainly used.)

2. Related Art

As described in Japanese Patent Laid-Open No. 11-326140, for example, in a vehicle, an electronic control unit for controlling an engine, transmission or the like has been adapted to be communicably connected to a malfunction diagnostic apparatus called “diagnostic tool” (or scanning tool) which is provided outside the vehicle.

In performing inspection and maintenance of a vehicle utilizing a vehicle diagnostic system having such a malfunction diagnostic apparatus and an electronic control unit, a serviceperson operates the malfunction diagnostic apparatus which is capable of communicating with the electronic control unit. In particular, when the serviceperson inputs a data ID indicative of certain data type into the malfunction diagnostic apparatus, the data ID is transmitted from the malfunction diagnostic apparatus to the electronic control unit. The electronic control unit then transmits, in response, data corresponding to the received data ID from among various data types possessed by the electronic control unit to the malfunction diagnostic apparatus. The data transmitted from the electronic control unit to the malfunction diagnostic apparatus is indicated on a display of the malfunction diagnostic apparatus.

When malfunction is detected, the electronic control unit is adapted to store a malfunction code (commonly known as “diagnostic code”) indicative of a type of the malfunction. Further, when a demand for reading out a malfunction code is received from the malfunction diagnostic apparatus, the electronic control unit is adapted to transmit the currently stored malfunction code to the malfunction diagnostic apparatus. The malfunction code transmitted in this way from the electronic control unit is also displayed on the malfunction diagnostic apparatus (refer, for example, to Japanese Patent Laid-Open No. 10-160642).

In this type of vehicle diagnostic system, when a serviceperson operates the malfunction diagnostic apparatus to input a forced driving code (commonly known as “forced driving ID”) for forcedly driving a certain object to be controlled, the forced driving code is transmitted from the malfunction diagnostic apparatus to the electronic control unit. Then, according to a predetermined pattern, the electronic control unit forcedly drives the object to be controlled indicated by the forced driving code received from the malfunction diagnostic apparatus.

As mentioned above, in specifying a malfunctioning portion of a vehicle in a maintenance shop of a car dealer, for example, it has been a practice for a serviceperson to adequately repeat the operations indicated at items (1) to (4) below so that the search for the malfunctioning portion can be narrowed down.

(1) To predict a failed function or a malfunctioning portion based on the report from the user and/or the contents of the malfunction code read out from the electronic control unit being demanded by the malfunction diagnostic apparatus.

(2) To consult a maintenance manual as to the data associated with the predicted matters (failed function or malfunctioning portion), and to input a data ID corresponding to the result of consultation into the malfunction diagnostic apparatus for transmission of the data ID from the malfunction diagnostic apparatus to the electronic control unit, so that an intended data can be transmitted, in response, from the electronic control unit to the malfunction diagnostic apparatus for display on the malfunction-diagnostic apparatus.

(3) To confirm a value of the data displayed on the malfunction diagnostic apparatus to determine whether or not the prediction at the above item (1) has been correct.

(4) To input a forced driving code into the malfunction diagnostic apparatus so as to forcedly drive an object to be controlled associated with the function that has been predicted as being in failure.

This is for confirmation for the practical driving conditions of the object to be controlled which is under the control of the electronic control unit. Then perform consultation and inputting operation similar to the above item (2) concerning the data in the electronic control unit, which data changes with the forced driving of the object to be controlled, so that the malfunctioning portion can be searched also based on the values of data displayed on the malfunction diagnostic apparatus.

In the conventional vehicle diagnostic system as described above, it has been necessary for a serviceperson to check every data associated with the function or portion that has been predicted as being in malfunction (i.e. data that should be monitored to specify a malfunctioning portion) by consulting a maintenance manual. Further, it has also been necessary for the serviceperson to confirm a data ID corresponding to each of the data by consulting the maintenance manual before operating the malfunction diagnostic apparatus. Generally, data to be monitored for specifying a malfunctioning portion depends on the malfunctioning portion. Therefore, search for the data to be monitored by consulting the maintenance manual has been a very time-consuming labor. In addition, in performing the operation of the above item (4), the data that changes with the forced driving of the object to be controlled has to be obtained by consulting the maintenance manual. Further, depending on the object to be controlled, which is subjected to the forced driving, the changing data are miscellaneous. Accordingly, searching all the data through the maintenance manual has imposed a very time-consuming labor on a serviceperson.

In this way, the conventional vehicle diagnostic system has required much longer time and a number of steps to specify a malfunctioning portion of a vehicle brought to a maintenance shop such as of a car dealer.

The present invention has an object of providing a vehicle diagnostic system which facilitates operation in specifying a malfunctioning portion of a vehicle.

### SUMMARY OF THE INVENTION

In order to realize the foregoing object, there is provided a system for diagnosing a malfunction concerning states of a vehicle in which an electronic control apparatus controlling the drive states is mounted and adapted to detect the malfunction and store therein data showing the malfunction. The system comprises a reference table and a malfunction diagnostic apparatus. In the reference table, there are stored a plurality of retrieval codes to which an operator has access and ID (identification) information identifying, among the data stored in the electronic control apparatus, data relating to contents shown by each of the retrieval codes are stored in advance, the retrieval codes expressing the malfunction concerning the states of the vehicle. The malfunction diagnostic apparatus is communicable with the electronic control apparatus. This malfunction diagnostic apparatus is able to retrieve from the reference table ID information corresponding to a retrieval code to be commanded and communicate with the electronic control apparatus to acquire data specified by the retrieved ID information from the electronic control apparatus.

In a preferred example, the retrieval codes are one or more codes composed of at least one type of retrieval code selected from three types of retrieval codes consisting of a first code inactive of types of diagnostic functions to the vehicle, a second code indicative of types of the malfunction, and a third code assigned to forcibly driving a specific device of the vehicle.

It is preferred that the reference table is provided in the electronic control apparatus mounted in the vehicle, and the malfunction diagnostic apparatus is communicable with the electronic control apparatus via a communication line and comprises transmission means for transmitting to the electronic control apparatus the commanded retrieval code and reception means for receiving from the electronic control apparatus the ID information corresponding to the commanded retrieval code.

In this configuration, it is still preferred that the electronic control apparatus comprises reception means for receiving the commanded retrieval code, retrieval means for retrieving from the reference table the ID information corresponding to the commanded retrieval code, and transmission means for transmitting the retrieved ID information to the malfunction diagnostic apparatus.

The reference table may be provided in various other components, not limited to being provided in the electronic control apparatus. By way of example, the reference table may be provided in an information processing apparatus communicable with the electronic control apparatus mounted in the vehicle. In this case, it is preferred that the malfunction diagnostic apparatus is communicable with the electronic control apparatus via a communication line and comprises transmission means for transmitting to the electronic control apparatus the commanded retrieval code and reception means for receiving from the electronic control apparatus the ID information corresponding to the commanded retrieval code; the electronic control apparatus comprises first relay means for receiving the commanded retrieval code and transmitting the received commanded retrieval code to the information processing apparatus and second relay means for receiving from the information processing information the ID information corresponding to the commanded retrieval code; and the information processing apparatus comprises reception means for receiving the commanded retrieval code from the electronic control apparatus, retrieval means for retrieving from the reference table the ID information corresponding to the commanded retrieval code, and transmission means for transmitting the retrieved ID information to the information processing apparatus.

Alternatively, the reference table may be provided in an information processing apparatus communicable with the malfunction diagnostic apparatus. In this case, it is preferred that the malfunction diagnostic apparatus comprises transmission means for transmitting to the information processing apparatus the commanded retrieval code and reception means for receiving from the information processing apparatus the ID information corresponding to the commanded retrieval code. It is also preferred that the information processing apparatus comprises reception means for receiving the commanded retrieval code, retrieval means for retrieving from the reference table the ID information corresponding to the commanded retrieval code, and transmission means for transmitting the retrieved ID information to the malfunction diagnostic apparatus.

### BRIEF DESCRIPTION OF THE DRAWINGS

In the accompanying drawings:

FIG. 1 is a block diagram illustrating an arrangement of a vehicle diagnostic system according to a first embodiment of the present invention;

FIG. 2 is an illustration explaining a data management table indicating relationship between-data IDs and data;

FIGS. 3A to 3C are illustrations of data ID retrieval tables;

FIG. 4 is a sequence diagram illustrating processes performed in a diagnostic tool and an electronic control unit (ECU), as well as transmission of information performed therebetween;

FIG. 5 is a flow diagram illustrating a procedure for obtaining data ID;

FIG. 6 is a flow diagram illustrating a procedure for demanding data;

FIG. 7 is a block diagram illustrating an arrangement of a vehicle diagnostic system according to a second embodiment of the present invention;

FIG. 8 is a sequence diagram illustrating processes performed in a diagnostic tool, an ECU and a center computer, as well as transmission of information performed therebetween;

FIG. 9 is a flow diagram illustrating a procedure of data ID retrieval;

FIG. 10 is a block diagram illustrating an arrangement of a vehicle diagnostic system according to a third embodiment of the present invention;

FIG. 11 is a sequence diagram illustrating processes performed in a diagnostic tool, an ECU and a database computer, as well as transmission of information performed therebetween;

FIG. 12 is a block diagram illustrating an arrangement of a vehicle diagnostic system according to a fourth embodiment of the present invention;

FIG. 13 is a sequence diagram illustrating processes performed in a diagnostic tool and an ECU, as well as transmission of information performed therebetween;

FIG. 14 is a sequence diagram illustrating a fifth embodiment according to the present invention;

FIG. 15 is a sequence diagram illustrating a sixth embodiment according to the present invention;

FIG. 16 is a sequence diagram illustrating a seventh embodiment according to the present invention;

FIG. 17 is a sequence diagram illustrating an eighth embodiment according to the present invention; and

FIG. 18 is an illustration explaining a first modification of the present invention.

### DETAILED DESCRIPTION OF THE PREFERRED EMBODIMENTS

Hereinafter are described various embodiments of a vehicle diagnostic system in which the present invention is applied. In the description provided below, an electronic control unit is referred to as an “ECU”.

### First Embodiment

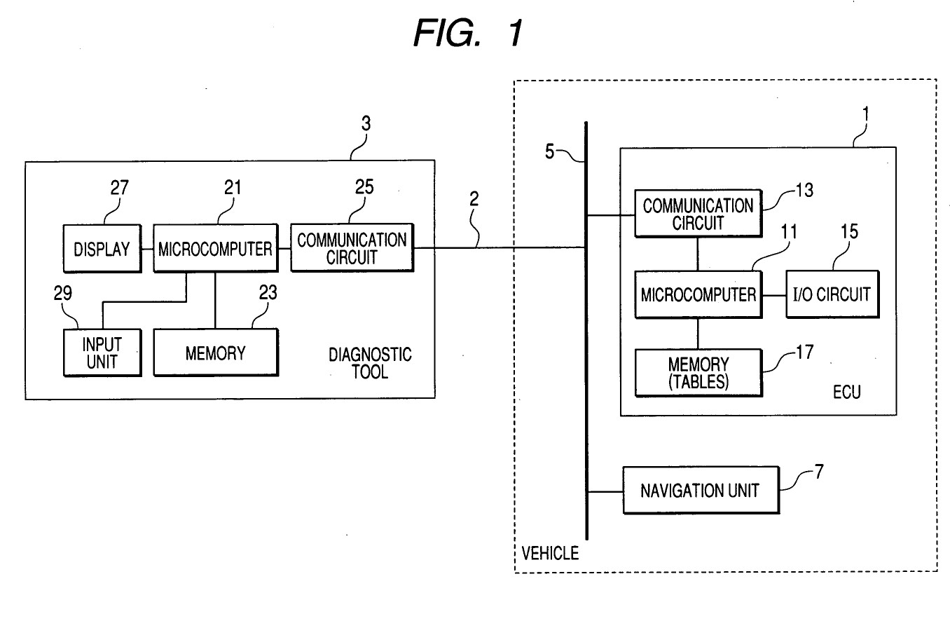

FIG. 1 is a block diagram illustrating an arrangement of a vehicle diagnostic system according to a first embodiment of the present invention.

As shown in FIG. 1, the vehicle diagnostic system of the first embodiment is made up of an ECU 1 which is loaded on a vehicle (automobile) to control an engine and an automatic transmission, and a malfunction diagnostic apparatus (hereinafter referred to as a “diagnostic tool”) 3 for reading out data from the ECU 1.

The ECU 1 is communicably connected to other on-vehicle apparatuses, such as a navigation unit 7, through a communication line 5 arranged in a vehicle. The ECU 1 is provided with a microcomputer 11 for governing the operation of the ECU 1, a communication circuit 13 for communicating with other units connected to the communication line 5, an I/O circuit 15 for inputting signals such as from various sensors and switches and for outputting signals for driving an actuator, and a nonvolatile memory 17.

The diagnostic tool 3 is provided with a microcomputer 21 for governing operation of the diagnostic tool 3, a memory 23, a communication circuit 25 for communicating with the ECU 1, a display 27 made up such as of a liquid crystal panel, and an input unit 29 made up of a plurality of inputting keys. The diagnostic tool 3 is communicably connected to the ECU1 by allowing a connector (not shown) provided at a tip of a communication cable 2 extending from the communication circuit 25 to fit into a connector (not shown) provided at the communication line 5 on the vehicle side.

Such a vehicle diagnostic system made up of the diagnostic tool 3 and the ECU 1 basically has the same function as the conventional system described above.

In particular, when a serviceperson (or an operator) who performs inspection and maintenance of an automobile connects the diagnostic tool 3 to the communication line 5 and operates the input unit 29 of the diagnostic tool 3 to input a data ID indicative of a certain data type, the data ID is transmitted to the ECU 1 from the diagnostic tool 3. Then, upon reception of the data ID from the diagnostic tool 3, the ECU 1 transmits, in response, data corresponding to the received data ID from among various data, such as calculation values possessed by the ECU 1 itself or detection values obtained from sensors, to the diagnostic tool 3. The diagnostic tool 3 receives the data transmitted in this way from the ECU 1 and displays the data on the display 27.

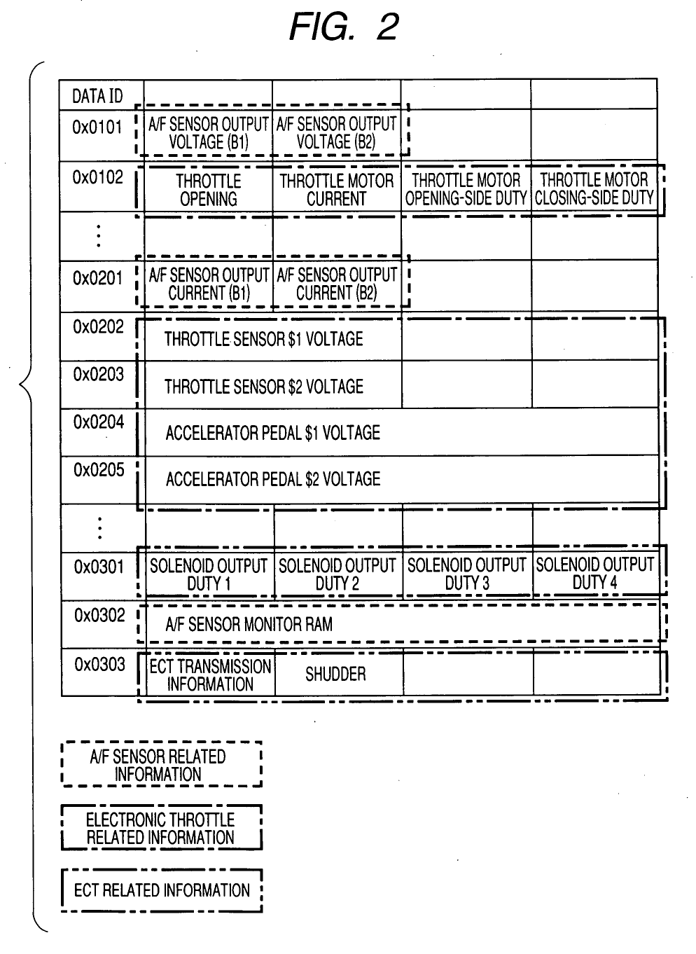

For this purpose, in the ECU 1, the memory 17 stores therein a communication data management table, for example, as shown in FIG. 2. Thus, upon reception of the data ID from the diagnostic tool 3, the ECU 1 is adapted to specify a data type corresponding to the data ID transmitted from the diagnostic tool 3 based on the communication data management table in the memory 17, and to transmit the latest version of the specified data type to the diagnostic tool 3.

As shown in FIG. 2, in the communication data management table, one or more data types corresponding to each of a plurality of data IDs are recorded. In FIG. 2, “#1”, “#2” . . . “#n” each indicate an order of the data types placed in a data region in one communication data to be transmitted from the ECU 1 to the diagnostic tool 3. For example, in case a data ID “0x0101” has been transmitted from the diagnostic tool 3 to the ECU 1, the ECU 1 transmits, in response, one communication data placing in its data region a data “A/F sensor output voltage (B1)” and a data “A/F sensor output voltage (B2)” in this order to the diagnostic tool 3.

It should be appreciated that, in FIG. 2, the “A/F sensor output voltage (B1)” means an output voltage of an A/F sensor (air/fuel sensor) provided at one of two exhaust systems (hereinafter referred to as a “first exhaust system”) in an engine, and the “A/F sensor output voltage (B2)” means an output voltage of an A/F sensor provided at the other of the two exhaust systems (hereinafter referred to as a “second exhaust system”). Similarly, an “A/F sensor output current (B1)” means an output current of the A/F sensor provided at the first exhaust system, and an “A/F sensor output current (B2)” means an output current of the A/F sensor provided at the second exhaust system. Further, an “A/F sensor monitor RAM” means calculation values associated with the A/F sensors, which values are calculated by the microcomputer 11 and stored in an RAM. For example, the calculation values include a value of an air/fuel ratio calculated on the basis of the output voltage and the output current of at least one of the two A/F sensors.

In FIG. 2, a “throttle motor current” represents a value of current that passes through a throttle motor which controls a throttle opening of the engine. A “throttle motor opening-side duty” represents a duty ratio in opening a throttle, among those duty ratios of driving signals for driving a throttle motor, and a “throttle motor closing-side duty” represents a duty ratio in closing the throttle, among those duty ratios of the driving signals. Further, a vehicle loaded with the ECU 1 according to the present embodiment is provided with two throttle sensors for detecting throttle opening, and two acceleration sensors for detecting an amount of operation of an accelerator pedal. In FIG. 2, a “throttle sensor $1 voltage” means an output voltage value of one throttle sensor, and a “throttle sensor $2 voltage” means an output voltage value of the other throttle sensor. Similarly, an “accelerator pedal $1 voltage” means an output voltage value of one accelerator sensor, and an “accelerator pedal $2 voltage” means an output voltage value of the other accelerator sensor.

In FIG. 2, “solenoid output duties 1 to 4” represent duty ratios of the driving signals for driving four respective solenoids for operating the automatic transmission. An “ECT shift information” means a value obtained by detecting the conditions of transmission gears, for example, of the automatic transmission. A “shudder” means a value obtained by detecting a level of vibration caused in the automatic transmission or the vehicle body.

In the vehicle diagnostic system according to the present invention, when malfunction is detected, the ECU 1 is adapted to store a malfunction code (hereinafter referred to as a “diagnostic code”) indicative of a type of malfunction. When a specific input operation is performed for the input unit 29, the diagnostic tool 3 demands the ECU 1 to read out the diagnostic code. The ECU 1, when the demand for reading out the diagnostic code is received from the diagnostic tool 3, is adapted to transmit the diagnostic code currently stored therein to the diagnostic tool 3. The diagnostic code transmitted in this way to the diagnostic tool 3 from the ECU 1 is also indicated on the display 27 of the diagnostic tool 3.

When an operator operates the input unit 29 of the diagnostic tool 3 to input a forced driving code (hereinafter referred to as a “forced driving ID”) for forcedly driving a certain object to be controlled, the forced driving ID is transmitted to the ECU 1 from the diagnostic tool 3. Upon reception of the forced driving ID from the diagnostic tool 3, the ECU 1 forcedly drives the object to be controlled indicated by the forced driving ID according to a predetermined pattern.

Thus, in the vehicle diagnostic system of the present embodiment as well, in identifying a malfunctioning portion of a vehicle, an operator may only adequately repeat the operations of the items (1) to (4) explained above. However, as described above, only repeating these operations may require much time and a number of steps in identifying a malfunctioning portion.

In order to take measure for this, the vehicle diagnostic system of the present invention is provided with an arrangement and a function as described hereunder.

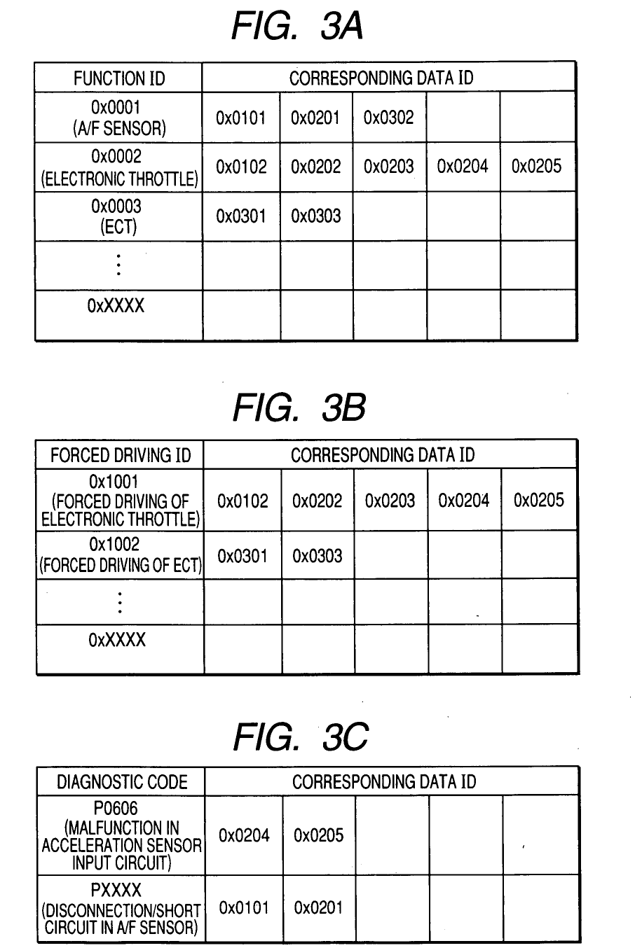

First of all, the memory 17 stores therein data ID retrieval tables as shown in FIGS. 3A to 3C.

In the data ID retrieval tables of the present embodiment, data IDs for the data which is considered to relate to the contents indicated by a retrieval code are recorded for each of a plurality of retrieval codes. Three types-of such a plurality of retrieval codes are provided, which are function IDs (corresponding to function codes) indicative of functions, forced driving IDs and the diagnostic codes.

For example, as shown in FIG. 3A, a function of an “A/F sensor” is allocated with a function ID “0x0001” as a retrieval code, a function of an “electronic throttle” is allocated with a function ID “0x0002” as a retrieval code, and a function of an “ECT” is allocated with a function ID “0x0003” as a retrieval code.

Data related to the function of the “A/F sensor” are considered to be those data (those data each begin with “A/F sensor”) enclosed by a dotted line in FIG. 2. Thus, the data IDs “0x0101”, “0x0201” and “0x0302” corresponding to each of the data are recorded being correlated with the function ID “0x0001” of the “A/F sensor”. Further, data related to the function of the “electronic throttle” are considered to be those data enclosed by a dashed-dotted line in FIG. 2. Thus, the data IDs “0x0102” and “0x0202” to “0x0205” corresponding to each of the data are recorded being correlated with the function ID “0x0002” of the “electronic throttle”. Furthermore, data related to the function of the “ECT” are considered to be those data enclosed by a dashed-two dotted line in FIG. 2. Thus, the data IDs “0x0301” and “0x0303” corresponding to each of the data are recorded being correlated with the function ID “0x0003” of the “ECT”.

For example, as shown in FIG. 3B, a forced driving ID for forcedly driving the electronic throttle is “0x1001”, while the data enclosed by the dashed-dotted in FIG. 2 are considered to change when the electronic throttle is forcedly driven. Therefore, the data IDs “0x0102and “0x0202” to “0x0205” corresponding to these data are recorded being correlated with the forced driving ID “0x1001”. Further, a forced driving ID for forcedly driving the automatic transmission is “0x1002”, while the data enclosed by the dashed-two dotted line in FIG. 2 are considered to change when the automatic transmission is forcedly driven. Therefore, the data IDs “0x0301 and “0x0303”corresponding to these data are recorded being correlated with the forced driving ID “0x1002”.

For example, as shown in FIG. 3C, a diagnostic code “P0606” is allocated to the malfunction of an acceleration sensor input circuit for inputting signals from the acceleration sensor. When the acceleration sensor input circuit is in malfunction, the “accelerator pedal $1 voltage” and the “accelerator pedal $2 voltage” are considered to be influenced. Therefore, the data IDs “0x0204” and “0x0205” corresponding to these data are recorded being correlated with the diagnostic code “P0606”.

Hereinafter are described detailed processes executed by the diagnostic tool 3 and the ECU 1, involving the data ID retrieval tables. It should be appreciated that the processes carried out by the diagnostic tool 3 are actually carried out by the microcomputer 21 in the diagnostic tool 3, and that the processes carried out by the ECU 1 is actually carried out by the microcomputer 11 in the ECU 1.

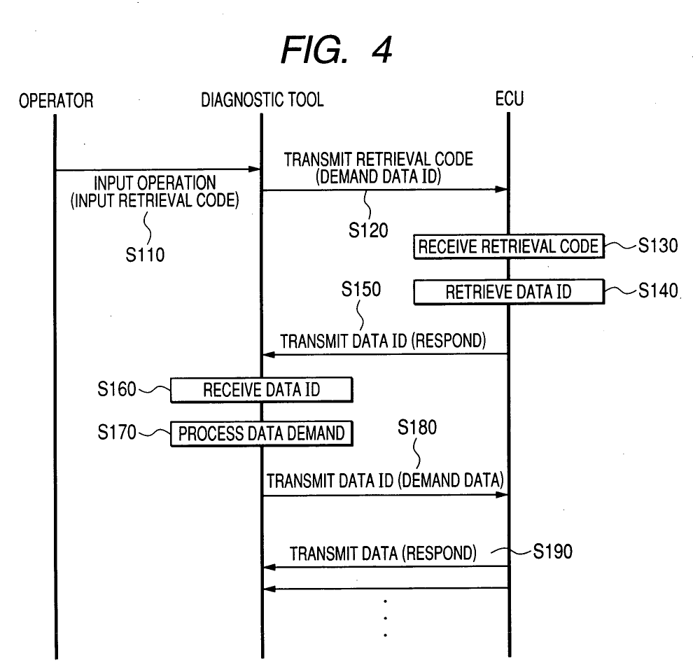

FIG. 4 is a sequence diagram illustrating the processes performed by the diagnostic tool 3 and the ECU 1 as well as information transmission performed therebetween.

As shown in FIG. 4, when an operator operates the input unit 29 of the diagnostic tool 3 to input a certain retrieval code which is either one of the function ID, the forced driving ID and the diagnostic code (S110), the diagnostic tool 3 transmits the inputted retrieval code to the ECU 1 (S120).

The inputting operation may be performed by inputting the retrieval code per se, but may be performed by a different manner. For example, the diagnostic tool 3 may be arranged such a way that: for the function IDs, input or selection of a function name can compel recognition that a function ID corresponding to the function name has been inputted; for the forced driving IDs, input or selection of a name of an object to be controlled can compel recognition that a forced driving ID corresponding to the name of the object has been inputted; and for the diagnostic codes, input or selection of a name of malfunction can compel recognition that a diagnostic code corresponding to the name of malfunction has been inputted.

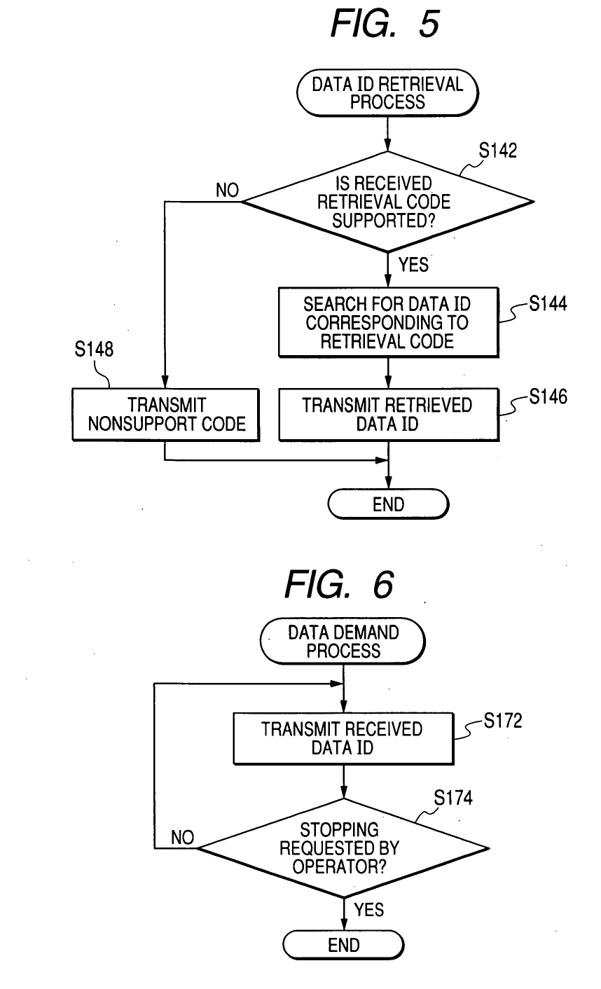

On the other hand, the ECU 1 receives the retrieval code transmitted from the diagnostic tool 3 (S130). The ECU 1 then carries out a process, as shown in FIG. 5, so that a data ID corresponding to the received retrieval code can be retrieved from the data ID retrieval tables (S140).

As shown in FIG. 5, in this data ID retrieval process, it is determined first whether or not the received retrieval code is supported (i.e. whether or not the retrieval code is recorded in the data ID retrieval tables stored in the memory 17) (S142). If supported (S142: YES), a data ID recorded in the data ID retrieval table being correlated with the retrieval code received from the diagnostic tool 3 is retrieved (S144). The retrieved data ID is transmitted to the diagnostic tool 3 (S146), and then the data ID retrieval process is ended.

Contrarily, if the received retrieval code is determined, at S142, as not being supported (S142: NO), a specific code indicative of the code as not being supported (code indicating nonsupport of the retrieval code) is transmitted to the diagnostic tool 3 (S148). Then, the data ID retrieval process is ended. The code indicating nonsupport of the retrieval code, which is transmitted to the diagnostic tool 3 at S148, is indicated on the display 27 of the diagnostic tool 3 for information for an operator.

Referring again to FIG. 4, when the data ID is transmitted at S146 of FIG. 5 by the ECU 1 (S150), the data ID transmitted from the ECU 1 is received by the diagnostic tool 3 (S160). Then, the diagnostic tool 3 carries out a data demand process (S170) shown in FIG. 6.

As shown in FIG. 6, in demanding data, the received data ID is transmitted to the ECU 1 as a demand for data (S172). In case a plurality of data IDs are received from the ECU 1, one of the received data is transmitted at this step.

Then, it is determined as to whether or not a request for stopping the process has been inputted by an operator (S174). If not (S174: NO), control returns to S172. At S172, a data ID among the data IDs received from the ECU 1, which is different from the one previously transmitted at this step S172 is transmitted. However, if all of the received data IDs have already been transmitted, control proceeds to S174 without processing anything this time. On the other hand, if an operator has inputted a request for stopping the process (S174: YES), the data demand process is ended.

Through the data demand process as described above, the data IDs retrieved from the data ID retrieval tables and transmitted to the diagnostic tool 3 by the ECU 1, are transmitted from the diagnostic tool 3 to the ECU 1 as a demand for data.

Referring to FIG. 4 again, when the diagnostic tool 3 transmits, at S172 of FIG. 6, the data ID to the ECU 1 as a demand for data (S180), the ECU 1, upon reception of the data ID from the diagnostic tool 3, transmits, in response, a data from among the various data possessed by itself, which corresponds to the received data ID, to the diagnostic tool 3 (S190) as described above. The diagnostic tool 3 thus receives the data transmitted from the ECU 1 and displays the data on the display 27.

As described above, according to the vehicle diagnostic system of the present embodiment, an operator does not have to consult the maintenance manual, for example, for every data to be monitored and for every data ID thereof in order to identify a malfunctioning portion of the vehicle. Instead, an operator only has to input a retrieval code into the diagnostic tool 3 to efficiently obtain data required for identifying a malfunctioning portion, whereby the time required for identifying a malfunctioning portion can be reduced.

For example, when a function ID as a retrieval code of a failed function is inputted by an operator, the data IDs of one or more data, which are regarded to associate with the function, are automatically retrieved from the data ID retrieval tables, and data corresponding to each of the retrieved data IDs is read out from the ECU 1 into the diagnostic tool 3 for display on the display 27.

Further, when the diagnostic tool 3 has read out a diagnostic code from the ECU 1, and the diagnostic code as a retrieval code is inputted by an operator, the data IDs of one or more data, which are regarded to associate with the malfunction indicated by the diagnostic code, are automatically retrieved from the data ID retrieval tables, and data corresponding to each of the retrieved data IDs is read out from the ECU 1 into the diagnostic tool 3 for display on the display 27.

Furthermore, when an operator inputs a forced driving ID for forcedly driving an object to be controlled in order to confirm the operation of the object, the object to be controlled indicated by the forced driving ID is forcedly driven by the ECU 1 with a predetermined pattern, and the data IDs of one or more data, which are regarded to change by driving the object to be controlled indicated by the forced driving ID, are automatically retrieved from the data ID retrieval tables. Then, data corresponding to each of the retrieved data IDs is read out from the ECU 1 into the diagnostic tool 3 for display on the display 27.

### Second Embodiment

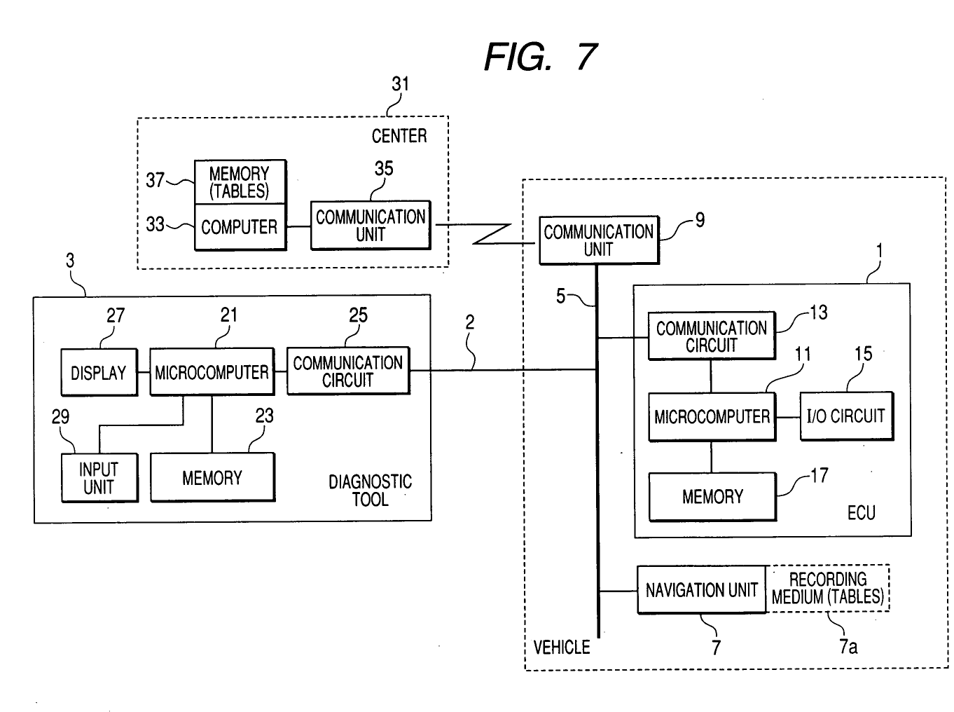

FIG. 7 is a block diagram illustrating an arrangement of a vehicle diagnostic system according to a second embodiment of the present invention. In FIG. 7, the identical or similar components to those illustrated in FIG. 1 are given the same references for the sake of omission of explanation.

The vehicle diagnostic system according to the second embodiment is different from the system in the first embodiment in that the second embodiment is additionally provided with a management center 31 outside a vehicle.

The management center 31 is provided with a computer (hereinafter referred to as a “center computer”) 33, to which a communication unit 35 for making radio communication with on-vehicle apparatuses is connected.

A memory 37 of the center computer 33 stores the data ID retrieval tables illustrated in FIG. 3 for all the types of vehicles to be subjected to maintenance. In particular, the data ID retrieval tables prepared for every type of vehicle are stored being correlated with vehicle IDs indicative of vehicle types. It should be appreciated that the data ID retrieval tables for every type of vehicle stored in the memory 37 are purposefully or automatically renewed as required. It should also be appreciated that the memory 37 is provided with a hard disc, a memory card, a CD-ROM or a DVD-ROM, for example, as a recording medium.

Meanwhile, a vehicle is provided with a communication unit 9 to make radio communication with the center computer 33. The communication unit 9 is connected to the on-vehicle apparatuses, such as the ECU 1, through the communication line 5. The center computer 33 and the ECU 1 communicate with each other through the communication unit 35 of the management center 31 and the vehicle-side communication unit 9.

In the second embodiment, the memory 17 of the ECU 1 does not store the data ID retrieval tables. Instead, the memory 17 stores a vehicle ID of the vehicle on which the ECU 1 itself is loaded (hereinafter referred to as a “subject-vehicle ID”).

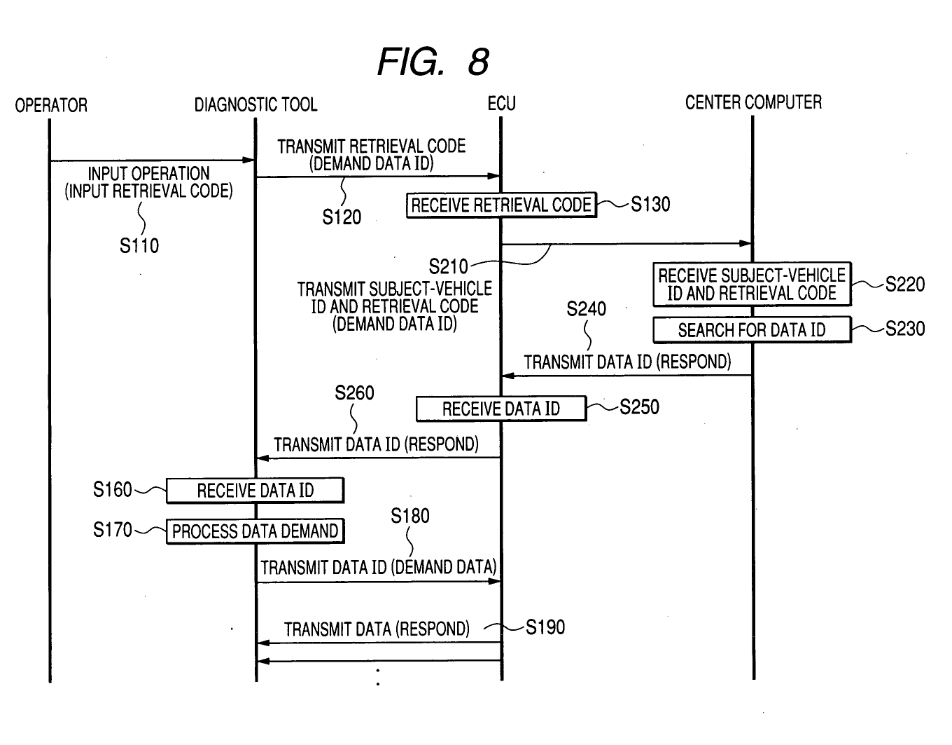

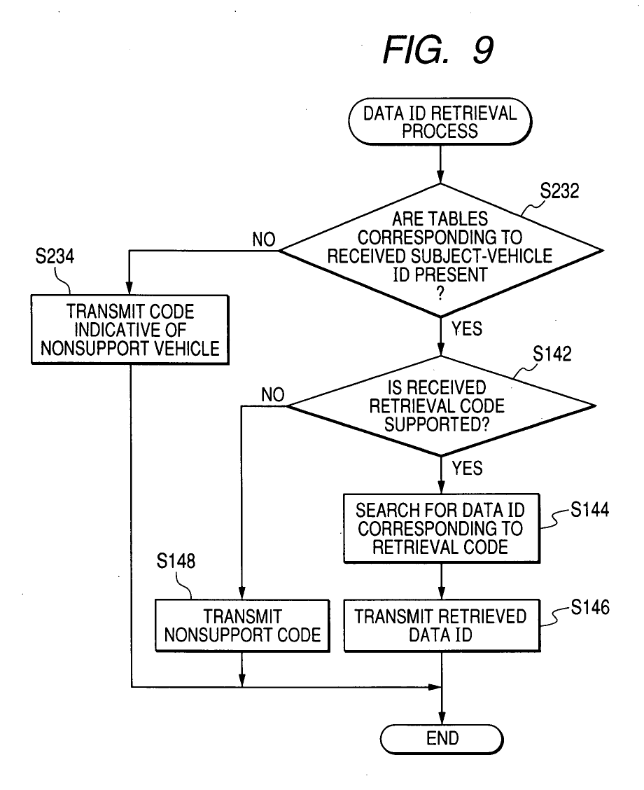

With reference to FIGS. 8 and 9, hereinafter is described the detailed processes executed by the diagnostic tool 3, the ECU 1 and the center computer 33.

FIG. 8 is a sequence diagram illustrating the processes performed by the diagnostic tool 3, the ECU 1 and the center computer 33, and information transmission performed therebetween. In FIG. 8, the identical or similar processes to those in FIG. 4 are given the same step reference numbers for omission of explanation.

In FIG. 8, the processes performed at S110 to S130 are the same as in FIG. 4. The ECU 1, upon reception of a retrieval code transmitted from the diagnostic tool 3 (S130), transmits the received retrieval code and the subject-vehicle ID in the memory 17 to the center computer 33 (S210).

Thus, the center computer 33 receives the subject-vehicle ID and the retrieval code from the ECU 1 (S220). The center computer 33 then executes a data ID retrieval process shown in FIG. 9 so as to retrieve a data ID corresponding to the received retrieval code by searching through the data ID retrieval tables. In FIG. 9, the identical or similar processes to those in FIG. 5 are given the same step reference numbers.

As shown in FIG. 9, in the data ID retrieval process, the data ID retrieval tables corresponding to the received subject-vehicle ID (hereinafter referred to as “subject-vehicle data ID retrieval tables”) are searched first through the memory 37 to determine whether or not the subject-vehicle data ID retrieval tables are stored in the memory 37 (S232).

If the subject-vehicle data ID retrieval tables are stored in the memory 37 (S232: YES), it is determined then whether or not the received retrieval code is supported in the subject-vehicle data ID retrieval tables (i.e. whether or not the received retrieval code is recorded on the subject-vehicle data ID retrieval tables) (S142).

If the received retrieval code is determined as being supported (S142: YES), a data ID recorded being correlated with the received retrieval code is retrieved from the subject-vehicle data ID retrieval tables (S144). Then, the retrieved data ID is transmitted to the ECU 1 (S146). After that, the data ID retrieval process is ended.

Contrarily, if the received retrieval code is determined, at S142, as not being supported, a specific code indicative of the retrieval code's not being supported (retrieval code nonsupport code) is transmitted to the ECU 1 (S148). After that, the data ID retrieval process is ended.

At S232, if the subject-vehicle data ID retrieval tables are determined as not being stored in the memory 37 (S232: NO), a specific code indicating that the vehicle connected to the diagnostic tool 3 (i.e. in this case, the vehicle that has transmitted the retrieval code to the management center 31) is not supported in the management center 31 (vehicle nonsupport code), is transmitted to the ECU 1 (S234), and then the data ID retrieval process is ended.

The codes transmitted at S148 and S234 are transmitted to the diagnostic tool 3 by way of the ECU 1, and are indicated on the display 27 of the diagnostic tool 3 for information for an operator.

Referring again to FIG. 8, when the center computer 33 transmits the data ID obtained at S146 of FIG. 9 (S240), the ECU 1, upon reception of the data ID from the center computer 33 (S250) transmits the received data ID to the diagnostic tool 3 (S260).

Subsequently, similar to the processes shown in FIG. 4, the diagnostic tool 3 receives the data ID from the ECU 1 (5160), executes the data demand process (S170) of FIG. 6 as described above, and transmits the data ID received from the ECU 1 to the ECU 1 as a data demand (S180).

In response, the ECU 1 transmits a data corresponding to the data ID received from the diagnostic tool 3 to the diagnostic tool 3 (S190). The data transmitted from the ECU 1 is then indicated on the display 27 of the diagnostic tool 3.

The vehicle diagnostic system of the second embodiment can exert an effect similar to the effect in the vehicle diagnostic system in the first embodiment. Comparing with the first embodiment, the ECU 1 of the second embodiment is not required to have the data ID retrieval tables so that a memory capacity required for the ECU 1 can be reduced that much.

In the second embodiment, from among the data ID retrieval tables for every type of vehicle stored in the memory 37, the subject-vehicle data ID retrieval tables are adapted to be automatically selected for use in the retrieval of a data ID. Therefore, an operator does not have to switch the data ID retrieval tables for confirmation of the type of the vehicle. In other words, an operator can carry out operation through a single procedure irrespective of the type of the vehicle.

In the second embodiment, the data ID retrieval tables for every type of vehicle may alternatively be stored in an on-vehicle apparatus different from the ECU 1, which apparatus is loaded on the vehicle together with the ECU 1, instead of storing in the center computer 33 in the management center 31. In this case, the ECU 1 is to communicate, as a matter of course, with the on-vehicle apparatus of interest storing the subject-vehicle data ID retrieval tables.

The on-vehicle apparatus for storing the data ID retrieval tables for every type of vehicle may preferably be the navigation unit 7. This is because the navigation unit 7 is generally provided with bulk storage means, such as a disc-type recording medium (e.g., a CD-ROM or a DVD-ROM) or a hard disc, so that even when the amount of information for the data ID retrieval tables is large, the navigation unit 7 may store the data ID retrieval tables in such bulk storage means. Also, in this case, the data ID retrieval tables may be stored in a recording medium 7a (see FIG. 7) detachable from the navigation unit 7. In this case, a user of the system can edit the data retrieval tables using a personal computer, instead of using a dedicated machine. The recording medium 7a may, for example, be a memory card, or a data writable/rewritable disc-type recording medium, such as a DVD-ROM or a DVD-RAM.

### Third Embodiment

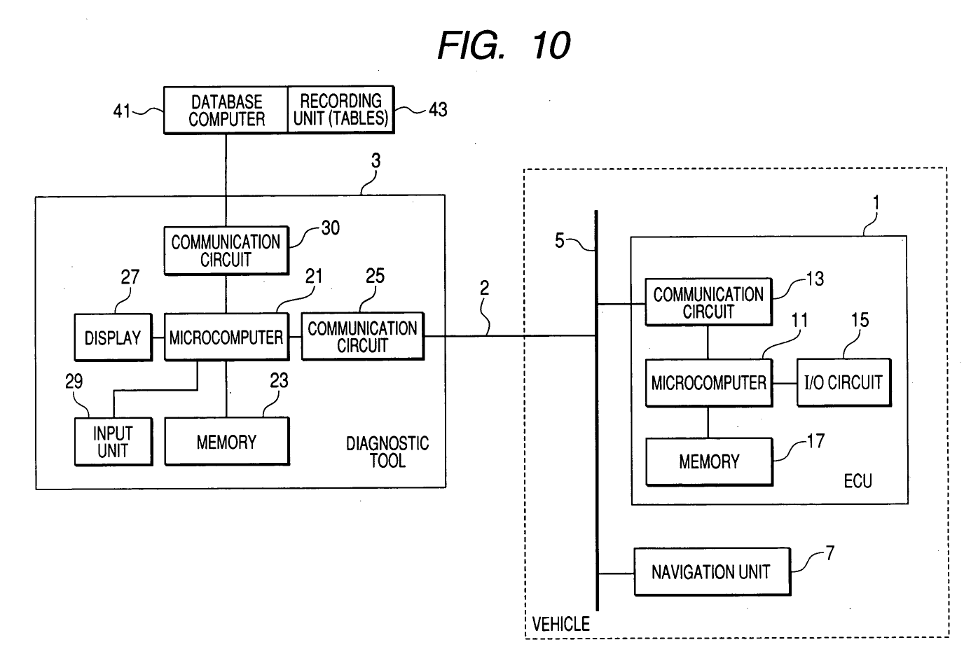

FIG. 10 is a block diagram illustrating an arrangement of a vehicle diagnostic system according to a third embodiment of the present invention. In FIG. 10, the identical or similar components to those in FIGS. 1 and 7 are given the same references for the sake of omitting explanation.

The vehicle diagnostic system of the third embodiment is different from the system of the second embodiment in that the system of the third embodiment is provided with a database computer 41, rather than the management center 31, which can be connected to the diagnostic tool 3. Similar to the memory 37 of the second embodiment, a memory 43 provided in the database computer 41 stores the data ID retrieval tables prepared for every type of vehicle, being correlated with vehicle IDs indicative of vehicle types. The memory used as the memory 43 is the same as the one used as the memory 37 of the second embodiment. It should be appreciated that the data ID retrieval tables for every type of vehicle stored in the memory 43 may also be purposefully or automatically renewed as required.

The diagnostic tool 3 is provided with a communication circuit 30 for communicating with the database computer 41.

In the third embodiment, the diagnostic tool 3 and the database computer 41 are adapted to communicate with each other. The communication between the both may be made over the radio. In the third embodiment as well, the memory 17 in the ECU 1 stores a subject-vehicle ID. In the third embodiment, the vehicle may be or may not be provided with the communication unit 9 for radio communication.

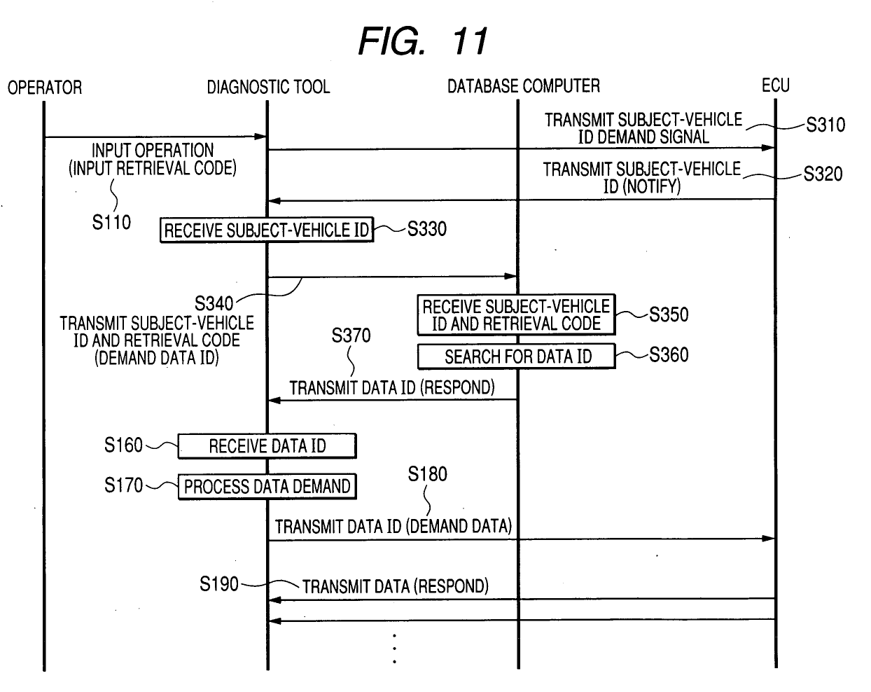

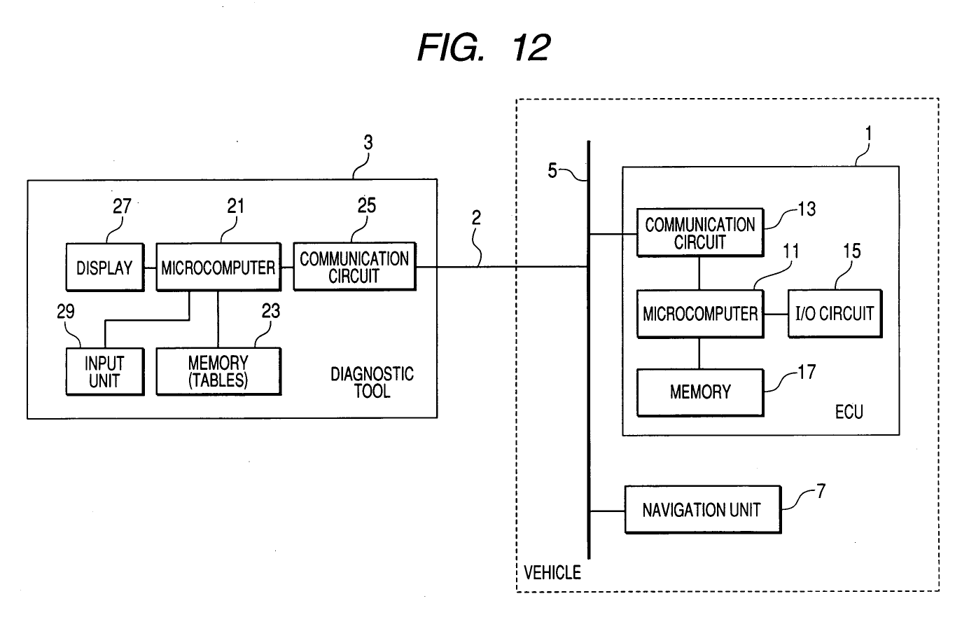

With reference to FIG. 11, hereinafter is described the processes executed by the diagnostic tool 3, the ECU 1 and the database computer 41.

FIG. 11 is a sequence diagram illustrating the processes executed by the diagnostic tool 3, the ECU 1 and the database computer 41, and the information transmission performed therebetween. In FIG. 11, the identical or similar processes to those in FIG. 4 are given the same step reference numbers.

As shown in FIG. 11, when a retrieval code is inputted to the diagnostic tool 3 by an operator (S110), the diagnostic tool 3 transmits a subject-vehicle ID demand signal for demanding a subject-vehicle ID to the ECU 1 (S310). The ECU 1, upon reception of the subject-vehicle ID demand signal, reads out the subject-vehicle ID stored in the memory 17 and transmits the subject-vehicle ID to the diagnostic tool 3 (S320). The subject-vehicle ID transmitted from the ECU 1 is then received by the diagnostic tool 3 (S330). In this way, the diagnostic tool 3 obtains the subject-vehicle ID.

After that, the diagnostic tool 3 transmits the subject-vehicle ID obtained from the ECU 1 and the retrieval code inputted by the operator to the database computer 41 (S340).

Thus, the database computer 41 receives the subject-vehicle ID and the retrieval code from the diagnostic tool 3 (S350). As in the case of the center computer 33 of the second embodiment, the database computer 41 executes the data ID retrieval process shown in FIG. 9 with respect to the received subject-vehicle ID and the retrieval code (S360).

In this case, at S232 of FIG. 9, the subject-vehicle data ID retrieval tables (the data ID retrieval tables corresponding to the received subject-vehicle ID) are searched through the memory 43. Also, at S146 of FIG. 9, the data ID retrieved from the subject-vehicle data ID retrieval tables is transmitted to the diagnostic tool 3. Further, at S148 and S234 of FIG. 9, the respective codes (the retrieval code nonsupport code and the vehicle nonsupport code) are transmitted to the diagnostic tool 3. Then, the codes transmitted at S148 and S234 are indicated on the display 27 of the diagnostic tool 3.

Referring again to FIG. 11, after the data ID has been transmitted, at S146 of FIG. 9, by the database computer 41 (S370), the subsequent processes are executed in a similar manner to those shown in FIG. 4. That is, the diagnostic tool 3 receives the data ID from the database computer 41 (S160), executes the data demand process (S170) of FIG. 6 as described above, and transmits the received data ID to the ECU 1 as a data demand (S180). In response, the ECU 1 transmits a data corresponding to the data ID received from the diagnostic tool 3 to the diagnostic tool 3 (S190). The data thus transmitted from the ECU 1 is indicated on the display 27 of the diagnostic tool 3.

The vehicle diagnostic system of the third embodiment as described above can also exert an effect similar to the one in the second embodiment. Further, comparing with the first and second embodiments, the third embodiment has an advantage of reducing the processes in the ECU 1, leading to the reduction in the process load imposed on the ECU 1.

### Fourth Embodiment

FIG. 12 is a block diagram illustrating an arrangement of a vehicle diagnostic system according to a fourth embodiment of the present invention. In FIG. 12, the identical or similar components to those in FIGS. 1, 7 and 10 are given the same references for the sake of omitting explanation.

The vehicle diagnostic system of the fourth embodiment is different from the system of the third embodiment in that the system of the fourth embodiment is not provided with the database computer 41, and that, therefore, the communication circuit 30 is omitted from the diagnostic tool 3. That is, from the view point of hardware, the arrangement of the fourth embodiment is the same as that of the first embodiment (see FIG. 1).

In the fourth embodiment, the data ID retrieval tables prepared for every type of vehicle are stored in the memory 23 of the diagnostic tool 3, being correlated with vehicle IDs indicative of vehicle types. In the fourth embodiment, the memory 17 of the ECU 1 also stores the subject-vehicle ID.

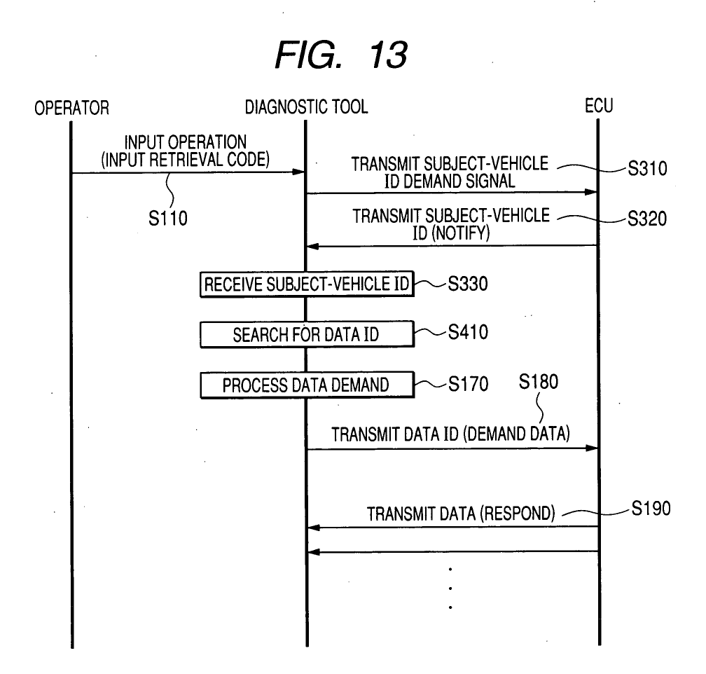

With reference to FIG. 13, hereinafter are described detailed processes carried out by the diagnostic tool 3 and the ECU 1.

FIG. 13 is a sequence diagram illustrating the processes carried out by the diagnostic tool 3 and the ECU 1 and the information transmission performed therebetween. In FIG. 13, the identical or similar processes to those in FIG. 11 described above are given the same step reference numbers.

In FIG. 13, the processes at S110 and S310 to S330 are the same as those in FIG. 11. When the diagnostic tool 3 receives the subject-vehicle ID from the ECU 1 (S330), the diagnostic tool 3 executes the data ID retrieval process similar to the one shown in FIG. 9 (S410) with respect to the received subject-vehicle ID and the retrieval code inputted by an operator.

The data ID retrieval process executed at S410 is different from the process executed at S230 of FIG. 9 in the following points.

At S232, the subject-vehicle data ID retrieval tables (the data ID retrieval tables corresponding to the received subject-vehicle ID) are determined first as to their storage at the memory 23. Then, at S142, it is determined whether or not the retrieval code inputted by an operator is supported in the subject-vehicle data ID retrieval tables (i.e. whether or not the retrieval code is recorded in the subject-vehicle data ID retrieval tables). Further, at S144, a data ID that has been recorded being correlated with the retrieval code inputted by an operator is retrieved from the subject-vehicle data ID retrieval table. Furthermore, the process executed at S146 is omitted. Finally, at S148 and S234, the respective codes (the retrieval code nonsupport code and the vehicle nonsupport code) are indicated on the display 27.

Referring again to FIG. 13, when the data ID retrieval process is ended, the diagnostic tool 3 executes the data demand process (S170) similar to the one illustrated in FIG. 6 with respect to the data ID retrieved from the subject-vehicle data ID retrieval tables in the data ID retrieval process. However, the data demand process executed by the diagnostic tool 3 in the fourth embodiment is different from the one illustrated in FIG. 6 in that, at S172, the data ID retrieved by the data ID retrieval process at S410 is transmitted to the ECU 1.

When the diagnostic tool 3 transmits the data ID with the data demand process (S180), the ECU 1 transmits, in response, a data corresponding to the data ID received from the diagnostic tool 3 to the diagnostic tool 3 (S190). The data thus transmitted from the ECU 1 is indicated on the display 27 of the diagnostic tool 3.

The vehicle diagnostic system of the fourth embodiment can also exert an effect similar to the effect of the system of the third embodiment. In comparison with the system of the third embodiment, the fourth embodiment has an advantage that the procedure and time for the diagnostic tool 3 to communicate with the database computer 41 can be omitted.

### Fifth Embodiment

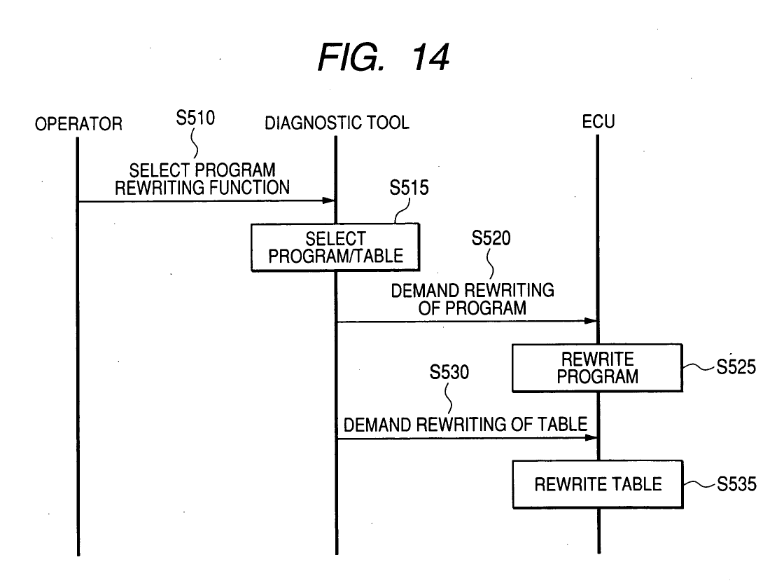

With reference to FIG. 14, hereinafter is described a vehicle diagnostic system according to the fifth embodiment of the present invention. In the present embodiment and the subsequent embodiments, components and processes identical or similar to those in the preceding embodiments are given the same references for the sake of omitting explanation.

The vehicle diagnostic system of the fifth embodiment is different from the system of the first embodiment in that the memory 17 in the first ECU 1 is a nonvolatile memory, such as a flash ROM or an EEPROM, which enables rewriting of data, and that the diagnostic tool 3 and the ECU 1 perform the processes shown in FIG. 14.

As shown in FIG. 14, when an operator or a serviceperson operates the input unit 29 of the diagnostic tool 3 and selects a program rewriting function (S510), the diagnostic tool 3 performs a process for selecting a control program that matches the ECU 1 and the data ID retrieval tables corresponding to the program (S515).

In particular, in the memory 23 of the diagnostic tool 3 or in a different memory (not shown) which is accessible from the diagnostic tool 3, control programs for every type of vehicle and data ID retrieval tables corresponding to each of the programs are stored being correlated with the respective vehicle IDs. When the program rewriting function is selected through an operation, a subject-vehicle ID is retrieved from the ECU 1 through a procedure similar to the procedure from S310 to S330 shown in FIGS. 11 and 13. Then, a control program and data ID retrieval tables corresponding to the retrieved subject-vehicle ID are selected from among the control programs and the data ID retrieval tables stored in the memory 23 or in the different memory. It should be appreciated that a control program refers to herein a program which is executed by the microcomputer 11 of the ECU 1 to control an object to be controlled, such as an engine or an automatic transmission. In the present embodiment, the control programs are stored in the memory 17 as far as the ECU 1 is concerned.

Then, the diagnostic tool 3 transmits to the ECU 1 a program rewriting demand and the control program selected at the above step S515 (S520). The ECU 1 then performs a program rewriting process for rewriting the control program stored in the memory 17 to the new control program transmitted from the diagnostic tool 3 (S525).

When the program rewriting process is completed in the ECU 1, the diagnostic tool 3 transmits to the ECU 1 a table rewiring demand and the data ID retrieval tables selected at the above step S515 (S530). The ECU 1 then performs a table rewriting process for rewriting tables stored in the memory 17 to the new data ID retrieval tables transmitted from the diagnostic tool 3 (S535).

In other words, the vehicle diagnostic system of the present invention is so arranged that, in rewriting the control program incorporated in the ECU 1, the data ID retrieval tables provided in the ECU 1 are also rewritten.

According to the vehicle diagnostic system of the present embodiment, mismatch is prevented from occurring between the program and the data ID retrieval tables in the ECU 1, which mismatch would have otherwise been caused by rewiring the program (reprogramming) of the ECU 1 after the vehicle has been marketed. Accordingly, a serviceperson who tries to identify a malfunctioning portion of a vehicle no longer has to confirm whether or not reprogramming of the ECU 1 has been performed in the past.

### Sixth Embodiment

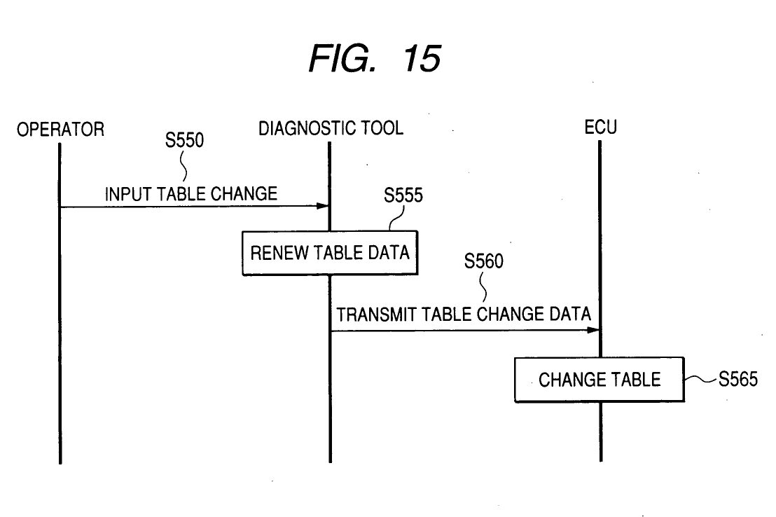

With reference to FIG. 15, hereinafter is described a vehicle diagnostic system according to a sixth embodiment of the present invention. The system of the sixth embodiment is different from the system of the first embodiment in that the memory 17 in the ECU 1 is a nonvolatile memory, such as a flash ROM or an EEPROM, which enables rewriting of data, and that the diagnostic tool 3 and the ECU 1 perform the processes shown in FIG. 15.

As shown in FIG. 15, when an operator or a serviceperson carries out an input operation through the input unit 29 of the diagnostic tool 3 in order to change the data ID retrieval tables (S550), the diagnostic tool 3 performs a table data renewing process to prepare a table renewal data, according to the contents of the input, so that a table provided in the ECU 1 is partially changed (S555).

In particular, an arrangement is so made that an operator can input a row number of a data ID retrieval table to be changed (i.e. a number of a region in which a retrieval code and a data ID corresponding thereto are described) as well as a new retrieval code and a new data ID to be described in the row, into the diagnostic tool 3 through the input unit 29. Then, the diagnostic tool 3 prepares a data indicative of the row number, the retrieval code and the data ID inputted by the operator so as to serve as a table renewal data.

Subsequently, the diagnostic tool 3 transmits the table renewal data prepared at the above step S555 to the ECU 1 (S560). The ECU 1 then carries out a table changing process to rewrite a data at the row number indicated by the table renewal data into the retrieval code and the data ID indicated by the table renewal data, among the data ID retrieval tables stored in the memory 17 (S565).

In other words, in the vehicle diagnostic system of the present embodiment, upon reception of the table renewal data (corresponding to a changing demand for instructing change of the contents of a data ID retrieval table) from the diagnostic tool 3, the ECU 1 is adapted to partially change a data ID retrieval table in the memory 17 according to the table renewal data.

According to the vehicle diagnostic system of the present embodiment, a serviceperson can freely customize the contents of the data ID retrieval tables in the ECU 1, whereby inspection/maintenance of a vehicle can be efficiently performed.

In the present embodiment, the input unit 29 of the diagnostic tool 3 has been operated by an operator for the renewal of the data ID retrieval tables in the ECU 1. Alternatively, however, the diagnostic tool 3 of FIG. 15 may be replaced by the navigation unit 7. Specifically, the navigation unit 7 may be operated by an operator or a serviceperson through an input unit provided thereto for changing the data ID retrieval tables, so that the navigation unit 7 can prepare the table renewal data mentioned above according to the contents of the input for transmission to the ECU 1.

Thus arranged vehicle diagnostic system of the present embodiment has an advantage that an operator can edit the contents of the data ID retrieval tables without using a dedicated machine such as for the diagnostic tool 3.

In the present embodiment, both of a retrieval code and a data ID of a data ID retrieval table have been changed, however, only a data ID, which is recorded being correlated with a retrieval code, may be changed.

### Seventh Embodiment

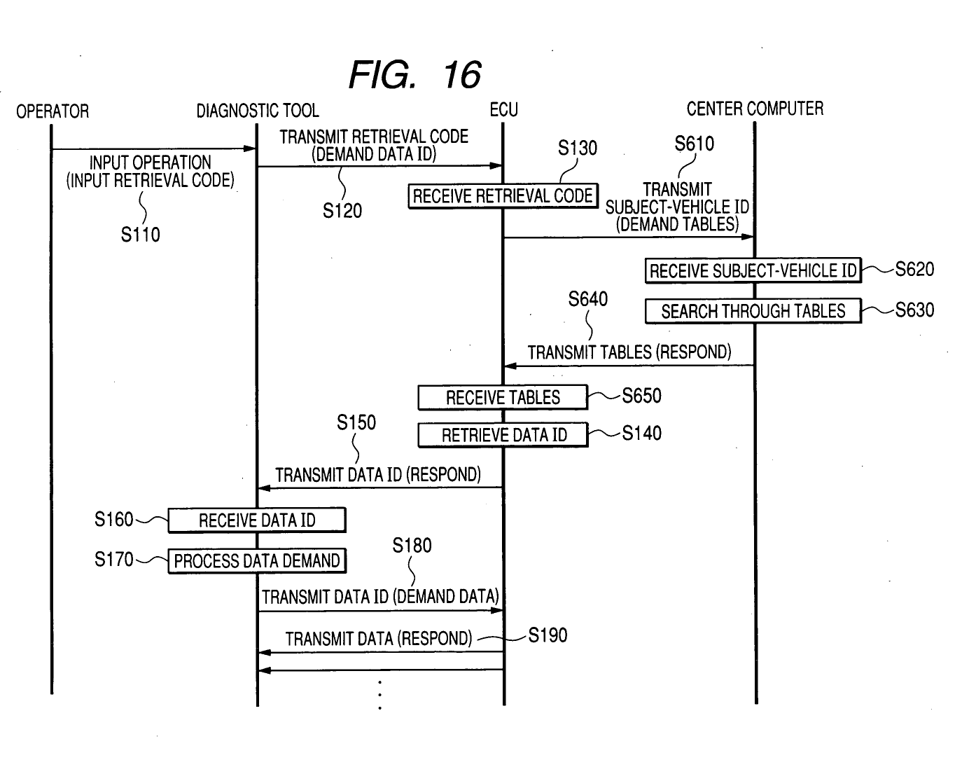

With reference to FIG. 16, hereinafter is described a vehicle diagnostic system according to a seventh embodiment of the present invention. The-system of the seventh embodiment is different from the system of the first embodiment in the following points.

In the first place, the present embodiment is additionally provided with the management center 31 similar to the one in the second embodiment. In particular, from a viewpoint of hardware, the present embodiment is similar to the second embodiment (FIG. 7).

In the second place, the memory 17 of the ECU 1 is a nonvolatile memory, such as a flash ROM or an EEPROM, which enables rewriting of data. In the memory, the subject-vehicle ID is stored in advance.

Finally, the diagnostic tool 3, the ECU 1 and the center computer 33 in the management center 31 are adapted to carry out the processes shown in FIG. 16. In FIG. 16, the processes similar to those in FIG. 4 are given the same step reference numbers for omission of explanation. FIG. 16 illustrates an operation performed at the time when the ECU 1 has received a retrieval code from the diagnostic tool 3 (S130) but the data ID retrieval tables are not stored in the memory 17, or, although the data ID retrieval tables are stored, the retrieval code received from the diagnostic tool 3 is not recorded in the tables.

As shown in FIG. 16, upon reception of the retrieval code transmitted from the diagnostic tool 3 (S130), the ECU 1 determines whether or not the retrieval code received from the diagnostic tool 3 is recorded in the data ID retrieval tables in the memory 17. When the data ID retrieval tables are not stored in the memory 17, or, although the data ID retrieval tables are stored, when the retrieval code received from the diagnostic tool 3 is not recorded in the tables, the ECU 1 transmits the subject-vehicle ID to the center computer 33 to demand the data retrieval tables (5610).

Thus, the center computer 33 receives the subject-vehicle ID from the ECU 1 (5620). The center computer 33 then carries out a table retrieval process for retrieving from the memory 37 the data ID retrieval tables (the subject-vehicle data ID retrieval table) corresponding to the received subject-vehicle ID (5630), and transmits the retrieved subject-vehicle data ID retrieval tables to the ECU 1 (5640).

Thus, the ECU 1 receives the data ID retrieval tables transmitted from the center computer 33 for renewal and storage in the memory 17 (S650).

The ECU 1 then carries out the data ID retrieval process (S140), as specifically shown in FIG. 5, for the data ID retrieval tables renewed and stored in the memory 17, and transmits, at S144 of the data ID retrieval process, a data ID retrieved from the data ID retrieval tables to the diagnostic tool 3 (S510). Subsequently, the processes of S160 to S190 described above are carried out. In this way, among the data in the ECU 1, a data of the data ID corresponding to the retrieval code inputted by the operator is indicated on the display 27 of the diagnostic tool 3.

If a retrieval code subsequently inputted by the operator into the diagnostic tool 3 is recorded in the data ID retrieval tables stored in the memory 17 of the ECU 1, the operation of FIG. 4 is performed without carrying out the processes of S610 to S650 of FIG. 16.

As described above, since the vehicle diagnostic system of the present embodiment allows the ECU 1 to download the data ID retrieval tables as required from the center computer 33 outside the vehicle for renewal and storage, the data ID retrieval tables retained in the ECU 1 can be efficiently renewed to reflect the latest information.

### Eighth Embodiment

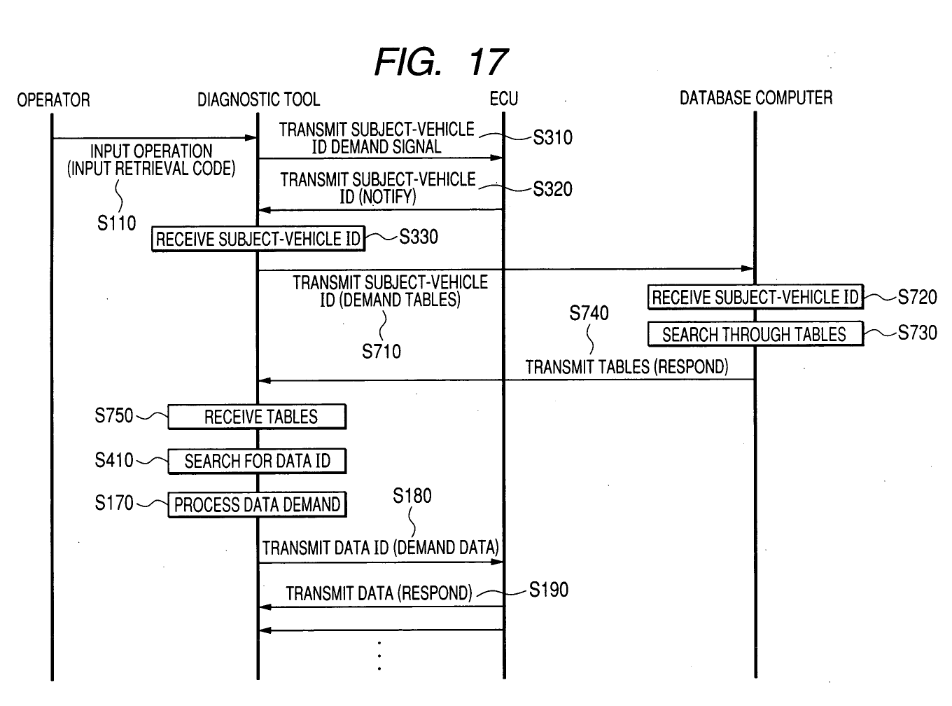

Referring to FIG. 17, a vehicle diagnostic system according to an eighth embodiment is described. The system of the eighth embodiment is different from the fourth embodiment in the following points.

In the first place, the database computer 41 similar to that of the third embodiment is connectable to the diagnostic tool 3. Specifically, from a viewpoint of hardware, the arrangement is similar to that of the third embodiment (FIG. 10).

In the second place, the memory 23 of the diagnostic tool 3 enables rewriting of data, and stores, as the data ID retrieval tables, only those which correspond to the subject vehicle to which the diagnostic tool 3 is connected (particularly, the subject-vehicle ID) through the processes that will be described later referring to FIG. 17.

Finally, when a retrieval code has been inputted for the first time after connection of the diagnostic tool 3 to the vehicle (particularly, to the communication line 5) in the eighth embodiment, the diagnostic tool 3, the ECU 1 and the database computer 41 are adapted to carry out the processes shown in FIG. 17.

In FIG. 17, the processes of S110 and S310 to S330 are the same as those in FIG. 13. Upon reception of the subject-vehicle ID from the ECU 1 (S330), the diagnostic tool 3 transmits the subject-vehicle ID to the database computer 41 (S710).

Thus, the database computer 41 receives the subject-vehicle ID from the diagnostic tool 3 (S720), and carries out a table retrieval process for retrieving the data ID retrieval tables corresponding to the received subject-vehicle ID (i.e., the subject-vehicle data ID retrieval tables) from the memory 43. Subsequently, the database computer 41 transmits the subject-vehicle data ID retrieval tables retrieved at the preceding step to the diagnostic tool 3 (S740).

Thus, the diagnostic tool 3 receives the data ID retrieval tables transmitted from the database computer 41 (i.e. the data ID retrieval tables that match the subject vehicle to which the diagnostic tool 3 is connected) for renewal/storage in the memory 23 (S750). Further, the diagnostic tool 3 carries out the data ID retrieval process (S410), which is similar to the process at S410 of FIG. 13.

At S232 (see FIG. 9) in the data ID retrieval process, if the data ID retrieval tables are stored in the memory 23, an affirmative determination “YES” is made. This is because the subject-vehicle data ID retrieval tables should have been downloaded in the memory 23 from the database computer 41. If the data ID retrieval tables have not been downloaded in the memory 23 for the reason, for example, that the subject-vehicle data ID retrieval tables had not been stored in the memory 43 on the side of the database computer 41, a negative determination “NO” is made at the above step S232.

Subsequently, the processes similar to those at S170 to S190 of FIG. 13 are carried out.

Further, when an operator inputs a subsequent retrieval code into the diagnostic tool 3, the processes of FIG. 17 excepting the steps S310 to S330 and S710 to S750 are carried out. Specifically, when a second and the subsequent retrieval codes are inputted one by one after connection of the vehicle to the diagnostic tool 3, the data ID corresponding to the inputted retrieval code is retrieved from the data ID retrieval tables in the memory 23, and the retrieved data ID is transmitted to the ECU 1 from the diagnostic tool 3 as a data demand.

According to the vehicle diagnostic system described above, the diagnostic tool 3 downloads, as required, the data ID retrieval tables from the database computer 41 for renewal and storage. Accordingly, the retained data ID retrieval tables can be efficiently renewed to reflect the latest information. In addition, comparing with the system of the fourth embodiment, the system of the present embodiment can set the storage capacity of the memory 23 at a small level.

(First Modification)

In the above embodiments, upon starting reception of data IDs one after another as a data demand from the diagnostic tool 3, the ECU 1 may continue transmitting a data corresponding to each of the received data IDs to the diagnostic tool 3 at predetermined timing until a transmission stopping demand is thereafter received from the diagnostic tool 3. In this case, an arrangement may be so made, for example, that the transmission stopping demand is transmitted to the ECU 1 in response to an operator's data monitor stopping operation through the input unit 29.

The arrangement mentioned above may reduce the data amount in the communication from the diagnostic tool 3 to the ECU 1, and may also reduce the communication process load imposed on both the diagnostic tool 3 and the ECU 1.

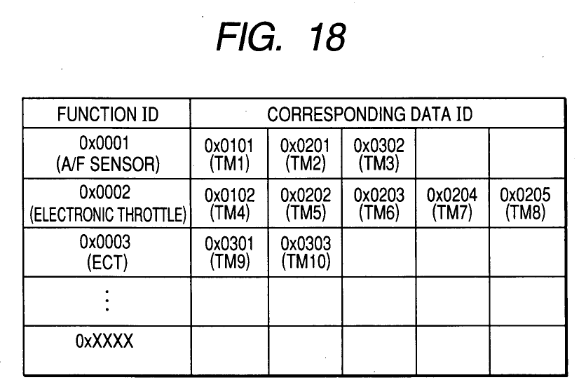

In this case, the following arrangement may be more preferable. As exemplified in FIG. 18, transmission timing (TM1, TM2, TM3, etc.) of a data indicated by each of the data IDs is also recorded being correlated with each of the data IDs in the data ID retrieval table.

After searching through the data ID retrieval tables for the data ID transmitted from the diagnostic tool 3, the ECU 1 is adapted to retrieve the transmission timing which is also recorded in the tables being correlated with the data ID transmitted from the diagnostic tool 3, and then to transmit a data corresponding to the data ID received from the diagnostic tool 3 at the retrieved transmission timing.

For example, as a modification of the first embodiment, every time a retrieval code is received from the diagnostic tool 3, the ECU 1 may search through the data ID retrieval tables in the memory 17 to retrieve, at S140 of FIG. 4 (particularly, at S144 of FIG. 5), a data ID corresponding to the retrieval code as well as a transmission timing recorded in the table being correlated with the data ID. The ECU 1 may then store the retrieved data ID and the transmission timing allowing them to correlate with each other. After that, every time a data ID, as a data demand, is received from the diagnostic tool 3, the ECU 1 may transmit a data corresponding to the data ID to the diagnostic tool 3 at the stored transmission timing.

As a modification of the second embodiment, every time a retrieval code is received from the ECU 1, the center computer 33 may search through the subject-vehicle data ID retrieval tables to retrieve, at S230 of FIG. 8 (particularly, at S144 of FIG. 9), a data ID corresponding to the retrieval code received from the ECU 1 as well as a transmission timing recorded in the table being correlated with the data ID. The center computer 33 then may transmit, at S240 of FIG. 8 (particularly, at S146 of FIG. 9), the retrieved data ID and the transmission timing to the ECU 1 allowing them to correlate with each other. Then, the ECU 1 may store the data ID and the transmission timing transmitted from the center computer 33 allowing them to correlate with each other. After that, every time a data ID, or a data demand, is received from the diagnostic tool 3, the ECU 1 may transmit a data corresponding to the data ID to the diagnostic tool 3 at the stored transmission timing.

As a modification of the third embodiment, every time a retrieval code is received from the diagnostic tool 3, the database computer 41 may search through the subject-vehicle data ID retrieval tables to retrieve, at S360 of FIG. 11, a data ID corresponding to the retrieval code received from the diagnostic tool 3 as well as a transmission timing recorded in the table being correlated with the data ID. The database computer 41 then may transmit, at S370 of FIG. 11, the retrieved data ID and the transmission timing to the diagnostic tool 3 allowing them to correlate with each other. Then, the diagnostic tool 3 may transmit, at S180 of FIG. 11 (particularly, at S172 of FIG. 6), a set of the data ID and the transmission timing corresponding to the data ID received from the database computer 41, to the ECU 1 so as to serve as a data demand. The ECU 1 then may store the data ID as a data demand and the transmission timing, transmitted from the diagnostic tool 3 allowing them to correlate with each other, and may transmit a data corresponding to the data ID to the diagnostic tool 3 every time the stored transmission timing has come.

As a modification of the fourth embodiment, every time a retrieval code is inputted by an operator, the diagnostic tool 3 may search through the subject-vehicle data ID retrieval tables to retrieve, at S410 of FIG. 13, a data ID corresponding to the retrieval code inputted by the operator as well as a transmission timing recorded in the table being correlated with the data ID. The diagnostic tool 3 then may transmit, at S180 of FIG. 13, a set of the retrieved data ID and transmission timing corresponding to the data ID to the ECU 1 so as to serve as a data demand. The ECU 1 may be arranged in the same manner as in the modification of the third embodiment described above.

The above arrangements enable determination on the timing of transmitting each of the data to the diagnostic tool 3 from the ECU 1 based on the data ID retrieval tables. Accordingly, an operation of setting the transmission timings in the order of importance, for example, may be facilitated.

(Second Modification)

The first embodiment may be modified as follows. Specifically, after searching through the data ID retrieval tables in the memory 17 to retrieve a data ID corresponding to the retrieval code received from the diagnostic tool 3 at S140 of FIG. 4 (particularly, at S144 of FIG. 5), the ECU 1 may transmit a data corresponding to the retrieved data ID to the diagnostic tool 3, rather than transmitting the retrieved data ID to the diagnostic tool 3. In short, this second modification omits the processes of S150 to S180 of FIG. 4.

According to the second modification, transmission of the data ID from the ECU 1 to the diagnostic tool 3 and vice versa can be omitted, whereby the communication process load imposed on both of the ECU 1 and the diagnostic tool 3, as well as the data amount of communication between them, can be reduced.

(Third Modification)

The second embodiment may be modified as follows. When the ECU 1 receives a data ID from the center computer 33 at S250 of FIG. 8, the ECU 1 may transmit a data corresponding to the data ID to the diagnostic tool 3, instead of transmitting the received data ID to the diagnostic tool 3. In short, the third modification omits the processes of S260 and S160 to S180 in FIG. 8.

The third modification can achieve the same effect as in the second modification.

Several embodiments of the present invention have been described above. However, the present invention is not intended to be limited by these embodiments, but, as a matter of course, may be implemented in various other embodiments without departing from the spirit of the present invention.

For example, the scheme of the second modification may be applied to the first modification concerning the first embodiment. Similarly, the scheme of the third modification may be applied to the first modification concerning the second embodiment.

Additionally, the diagnostic tool 3 and the ECU 1 may communicate with each other over the radio.

The present invention may be embodied in several other forms without departing from the spirit thereof. The embodiments and modifications described so far are therefore intended to be only illustrative and not restrictive, since the scope of the invention is defined by the appended claims rather than by the description preceding them. All changes that fall within the metes and bounds of the claims, or equivalents of such metes and bounds, are therefore intended to be embraced by the claims.

What is claimed is:

1. A system for diagnosing a malfunction concerning states of a vehicle in which an electronic control apparatus controlling the drive states is mounted and adapted to detect the malfunction and store therein data showing the malfunction, the system comprising
a reference table in which a plurality of retrieval codes to which an operator has access and ID (identification) information identifying, among the data stored in the electronic control apparatus, data relating to contents shown by each of the retrieval codes are stored in advance, the retrieval codes expressing the malfunction concerning the states of the vehicle; and
a malfunction diagnostic apparatus being communicable with the electronic control apparatus, retrieving from the reference table ID information corresponding to a retrieval code to be commanded; and communicating with the electronic control apparatus to acquire data specified by the retrieved ID information from the electronic control apparatus.

2. The system of claim 1, wherein the retrieval codes are one or more codes composed of at least one type of retrieval code selected from three types of retrieval codes consisting of a first code indicative of types of diagnostic functions to the vehicle, a second code indicative of types of the malfunction, and a third code assigned to forcibly driving a specific device of the vehicle.

3. The system of claim 1, wherein
the reference table is provided in the electronic control apparatus mounted in the vehicle, and
the malfunction diagnostic apparatus is communicable with the electronic control apparatus via a communication line and comprises transmission means for transmitting to the electronic control apparatus the commanded retrieval code and reception means for receiving from the electronic control apparatus the ID information corresponding to the commanded retrieval code.

4. The system of claim 3, wherein
the electronic control apparatus comprises reception means for receiving the commanded retrieval code, retrieval means for retrieving from the reference table the ID information corresponding to the commanded retrieval code, and transmission means for transmitting the retrieved ID information to the malfunction diagnostic apparatus.

5. The system of claim 1, wherein
the reference table is provided in an information processing apparatus communicable with the electronic control apparatus mounted in the vehicle,
the malfunction diagnostic apparatus is communicable with the electronic control apparatus via a communication line and comprises transmission means for transmitting to the electronic control apparatus the commanded retrieval code and reception means for receiving from the electronic control apparatus the ID information corresponding to the commanded retrieval code,
the electronic control apparatus comprises first relay means for receiving the commanded retrieval code and transmitting the received commanded retrieval code to the information processing apparatus and second relay means for receiving from the information processing apparatus the ID information corresponding to the commanded retrieval code, and
the information processing apparatus comprises reception means for receiving the commanded retrieval code from the electronic control apparatus, retrieval means for retrieving from the reference table the ID information corresponding to the commanded retrieval code, and transmission means for transmitting the retrieved ID information to the information processing apparatus.

6. The system of claim 1, wherein
the reference table is provided in an information processing apparatus communicable with the malfunction diagnostic apparatus,
the malfunction diagnostic apparatus comprises transmission means for transmitting to the information processing apparatus the commanded retrieval code and reception means for receiving from the information processing apparatus the ID information corresponding to the commanded retrieval code.

7. The system of claim 6, wherein
the information processing apparatus comprises reception means for receiving the commanded retrieval code, retrieval means for retrieving from the reference table the ID information corresponding to the commanded retrieval code, and transmission means for transmitting the retrieved ID information to the malfunction diagnostic apparatus.

8. The system of claim 1, wherein
the reference table is provided in the malfunction diagnostic apparatus and
the malfunction diagnostic apparatus comprises means for retrieval means for retrieving from the reference table the ID information corresponding to the commanded retrieval code.

9. The system of claim 1, wherein
the reference table is composed of a plurality of reference tables provided every type of the vehicle.

10. The system of claim 5, wherein
the reference table is composed of a plurality of reference tables provided every type of the vehicle,
the first relay means is configured to transmit to the information processing apparatus ID information indicating the type of the vehicle in which the electronic control apparatus is mounted, in addition to the commanded retrieval code,
the reception means of the information processing apparatus is configured to receive the commanded retrieval code and the vehicle-type ID information, and
the retrieval means of the information processing apparatus is configured to retrieve, from a reference table specified by the vehicle-type ID information among the plural reference tables, the ID information corresponding to the commanded retrieval code.

11. The system of claim 7, wherein
the reference table is composed of a plurality of reference tables provided every type of the vehicle,
the malfunction diagnostic apparatus comprises means for acquiring, from the electronic control apparatus, ID information indicating the type of the vehicle in which the electronic control apparatus mounted,
the transmission means of the malfunction diagnostic apparatus is configured to transmit to the information processing apparatus the acquired vehicle-type ID information in addition to the commanded retrieval code, and
the retrieval means of the information processing apparatus is configured to retrieve, from a reference table specified by the vehicle-type ID information among the plural reference tables, the ID information corresponding to the commanded retrieval code.

12. The system of claim 8, wherein
the reference table is composed of a plurality of reference tables provided every type of the vehicle,
the malfunction diagnostic apparatus comprises means for acquiring, from the electronic control apparatus, ID information indicating the type of the vehicle in which the electronic control apparatus mounted,
the retrieval means is configured to retrieve, from a reference table specified by the vehicle-type ID information among the plural reference tables, the ID information corresponding to the commanded retrieval code.

13. The system of claim 4, wherein the reference table is configured to update contents about the plurality of retrieval codes and the ID information every time when programs implemented in the electronic control apparatus are rewritten.

14. The system of claim 4, wherein
the malfunction diagnostic apparatus comprises means for transmitting, to the electronic control apparatus, a request for updating contents about the plurality of retrieval codes and the ID information written in the reference table, and
the electronic control apparatus comprises means for updating the contents written in the reference table in response to the updating request.

15. The system of claim 4, wherein
the electronic control apparatus comprises means for updating contents about the plurality of retrieval codes and the ID information written in the reference table in response to receiving, from a navigation apparatus mounted in the vehicle, a request for updating the contents.

16. The system of claim 4, wherein
the electronic control apparatus comprises means for downloading contents about the plurality of retrieval codes and the ID information and memorizing the downloaded contents in the reference memory, from an information processing apparatus placed outside the vehicle.

17. The system of claim 8, wherein
the malfunction diagnostic apparatus comprises means for downloading contents about the plurality of retrieval codes and the ID information and memorizing the downloaded contents in the reference memory, from an information processing apparatus placed outside the system.

18. The system of claim 5, wherein the information processing apparatus is a navigation apparatus mounted in the vehicle.

19. The system of claim 10, wherein the information processing apparatus is a navigation apparatus mounted in the vehicle.

20. The system of claim 18, wherein the reference table is implemented on an information recording medium detachable from the navigation apparatus.

21. The system of claim 18, wherein the reference table is implemented on an information recording medium detachable from the navigation apparatus.

22. The system of claim 1, wherein
the malfunction diagnostic apparatus comprises means for transmitting a request for stopping the transmission of the data specified by the retrieved ID information to the malfunction diagnostic apparatus; and
the electronic control apparatus comprises means for receiving the retrieved ID information from the malfunction diagnostic apparatus,
means for reading out the data specified by the retrieved ID information, and
means for consecutively transmitting, to the malfunction diagnostic apparatus, the read-out data until receiving from the malfunction diagnostic apparatus the stopping request.

23. The system of claim 22, wherein
the reference table configured to additionally memorize information showing transmission timing at which the data specified by the ID information is transmitted, the transmission timing being memorized every ID information, and
the electronic control apparatus comprises means for reading out, from the reference table, transmission timing decided based on the received ID information,
wherein the consecutive transmitting means is configured to transmit, to the malfunction diagnostic apparatus, the read-out data at the read-out transmission timing.

24. A method of diagnosing a malfunction concerning states of a vehicle in which an electronic control apparatus controlling the drive states is mounted and adapted to detect the malfunction and store therein data showing the malfunction, comprising the steps of:
retrieving, from a reference table in which a plurality of retrieval codes to which an operator has access and ID (identification) information identifying, among the data stored in the electronic control apparatus, data relating to contents shown by each of the retrieval codes are stored in advance and the retrieval codes expressing the malfunction concerning the states of the vehicle, ID information corresponding to a retrieval code to be commanded; and
communicating with the electronic control apparatus to acquire data specified by the retrieved ID information from the electronic control apparatus.

25. The system of claim 23, wherein the retrieval codes are one or more codes composed of at least one type of retrieval code selected from three types of retrieval codes consisting of a first code indicative of types of diagnostic functions to the vehicle, a second code indicative of types of the malfunction, and a third code assigned to forcibly driving a specific device of the-vehicle.
